(19) United States
(12) Patent Application Publication
(10) Pub. No.: US 2005/0222907 A1
(43) Pub. Date: Oct. 6, 2005

(54) Method to promote branded products and/or services

(76) Inventor: Anthony J. Pupo, Winter Park, FL (US)

Correspondence Address: HAHN LOESER & PARKS, LLP, One GOJO Plaza, Suite 300, AKRON, OH, 44311-1076, US

(21) Appl. No.: 11/091,698

(22) Filed: Mar. 28, 2005

Related U.S. Application Data
(60) Provisional application No. 60/558,540, filed on Apr. 1, 2004.

(51) Int. Cl. G06F 17/60

(52) U.S. Cl. 705/14

(57) ABSTRACT

A method to promote a business entity's branded products and/or services is disclosed. The method includes running a promotional software application on a personal computer system to display an animated character on a desktop of the personal computer system. A design of the animated character promotes branded products and/or services, of a business entity, to a user of the personal computer system. The method further includes the promotional software application automatically and periodically gathering promotional information of the business entity from a computer-based networked system associated with the business entity via a global informational network, such as the Internet, connected between the computer-based networked system and the personal computer system. The promotional software application communicates the promotional information of the business entity to the user via the animated character on the desktop. The promotional software application may, optionally, also gather information from the user from time to time and communicate the information back to the computer-based networked system.

### CROSS-REFERENCE TO RELATED APPLICATIONS/INCORPORATION BY REFERENCE

This patent application claims priority to U.S. provisional patent application Ser. No. 60/558,540 which was filed on Apr. 1, 2004, and is incorporated herein by reference in its entirety.

### TECHNICAL FIELD

Certain embodiments of the present invention relate to brand promotion. More particularly, certain embodiments of the present invention relate to a method, implemented as a software application on a user's personal computer system, to promote branded products and/or services of a client to the user via the user's personal computer system which is connected to a global informational network.

### BACKGROUND OF THE INVENTION

Advertisers use many different techniques and strategies to promote branded products and/or services to potential customers. Radio, television, newspapers, and magazines are traditional mediums of advertising and brand promotion. With the advent of the personal computer and the Internet, brand promotion in the form of pop-up advertisements and banners on web sites have become very common.

It is desirable to provide a method of brand promotion using personal computers and a global information network, such as the Internet, to provide a more persistent and consistent promotion of brands to a known customer.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

An embodiment of the present invention comprises a method to promote a business entity's branded products and/or services. The method comprises running a promotional software application on a personal computer system to display an animated character on a desktop of the personal computer system, wherein a design of the animated character promotes branded products and/or services, of a business entity, to a user of the personal computer system. The method further comprises the promotional software application automatically and periodically gathering promotional information of the business entity from a computer-based networked system associated with the business entity via a global informational network connected between the computer-based networked system and the personal computer system. The promotional software application communicates the promotional information of the business entity to the user via the animated character on the desktop.

An embodiment of the present invention comprises a promotional software application to promote a business entity's branded products and/or services. The promotional software application comprises an animation capability to display an animated character on a desktop of a personal computer system of a user on which the promotional software application is installed, and wherein a design of the animated character promotes branded products and/or services of the business entity. The promotional software application further comprises an information gathering capability wherein the promotional software application automatically and periodically accesses a computer-based networked system associated with the business entity, via a global informational network connected between the computer-based networked system and the personal computer system, and gathers promotional information from the computer-based networked system and brings the promotional information back to the personal computer system. The promotional software application also includes a user interface capability to facilitate communication between said promotional software application and said user.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a schematic block diagram of an embodiment of a personal computer (PC) system displaying an exemplary desk top view with an exemplary animated character, in accordance with various aspects of the present invention.

FIG. 2 illustrates a blown-up view of the desk top view of FIG. 1, in accordance with an embodiment of the present invention.

FIG. 3 illustrates a functional schematic block diagram of an embodiment of the promotional software application installed on the personal computer system of FIG. 1, in accordance with various aspects of the present invention.

FIG. 4 illustrates a schematic block diagram of an exemplary embodiment of a first system which includes the personal computer system of FIG. 1, in accordance with various aspects of the present invention.

FIG. 5 is a flowchart of an embodiment of a method to promote a business entity's branded products and/or services using the system of FIG. 4, in accordance with various aspects of the present invention.

FIG. 6 illustrates an exemplary embodiment of a desktop view using an animated character to communicate a notification message via a text bubble, in accordance with various aspects of the present invention.

FIG. 7 illustrates an exemplary embodiment of a drop-down menu that is displayed on the desktop of FIG. 1, in accordance with various aspects of the present invention.

FIG. 8 illustrates an exemplary embodiment of a new email view that is displayed to the user on the PC screen of FIG. 1 when the “New Email” option is selected, in accordance with various aspects of the present invention.

FIG. 9 illustrates an exemplary embodiment of the animated character announcing the time and date in a text bubble on a desktop view, in accordance with various aspects of the present invention.

FIG. 10 illustrates an exemplary embodiment of an address book view that is displayed to the user on the PC screen of FIG. 1 when the “Address Book” option is selected, in accordance with various aspects of the present invention.

FIG. 11 illustrates an exemplary embodiment of a search view that is displayed to the user on the PC screen of FIG. 1 when the “Search” option is selected, in accordance with various aspects of the present invention.

FIG. 12 illustrates a schematic block diagram of an exemplary embodiment of a second system which includes the personal computer system of FIG. 1, in accordance with various aspects of the present invention.

FIG. 13 illustrates a schematic block diagram of an exemplary embodiment of a third system which includes the personal computer system of FIG. 1, in accordance with various aspects of the present invention.

FIG. 14 illustrates a flowchart of an embodiment of a method to provide inspirational and motivational messages, in accordance with various aspects of the present invention.

### DETAILED DESCRIPTION OF THE INVENTION

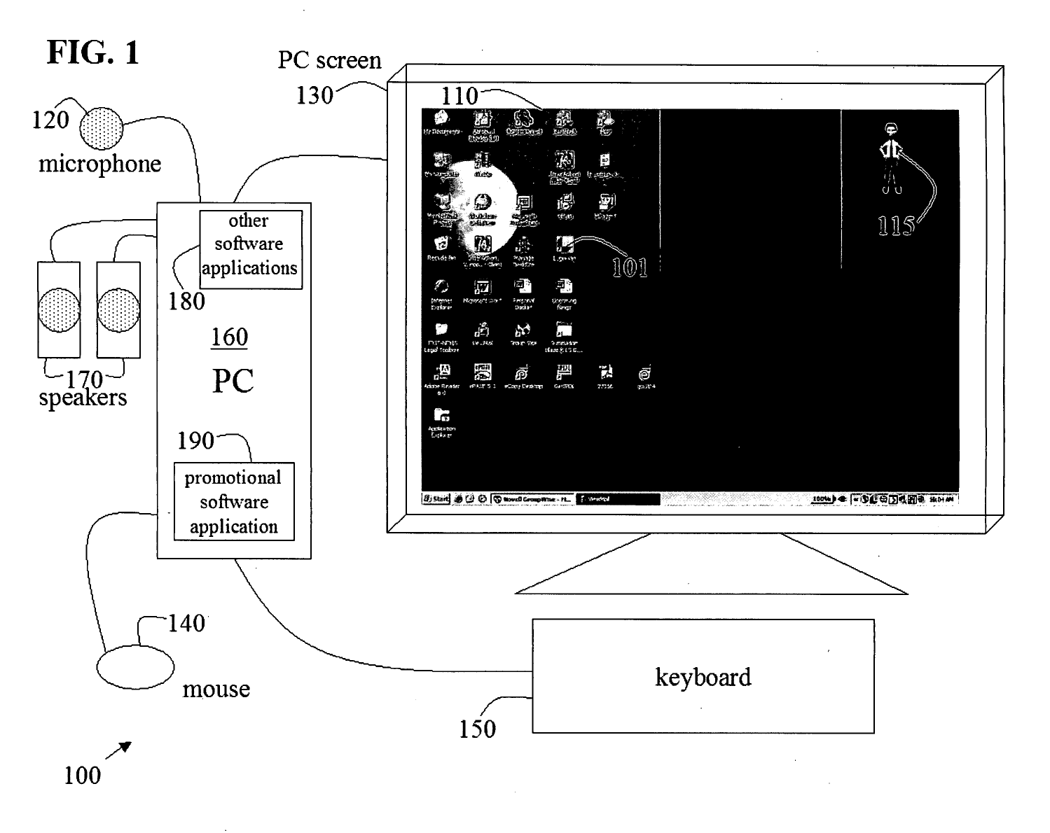

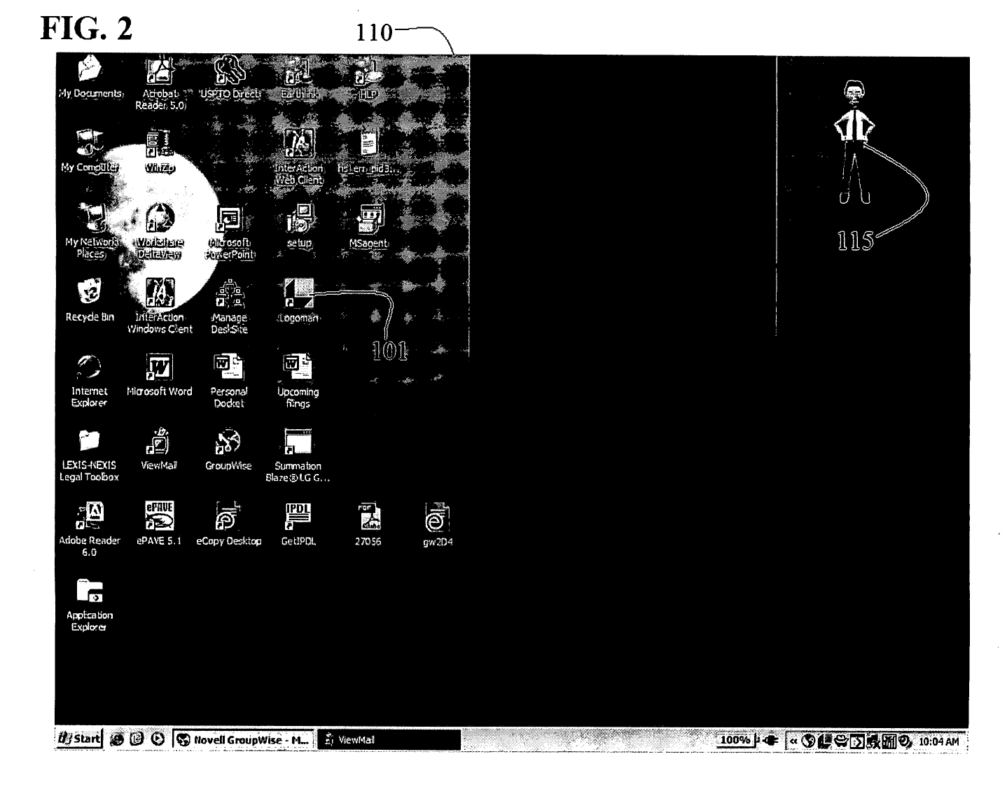

FIG. 1 illustrates a schematic block diagram of an embodiment of a personal computer (PC) system 100 displaying an exemplary desk top view 110 with an exemplary animated character 115, in accordance with various aspects of the present invention. FIG. 2 illustrates a blown-up view of the desk top view 110 of FIG. 1, in accordance with an embodiment of the present invention.

The PC system 100 includes a microphone 120, a display screen 130, a mouse 140, a keyboard 150, a PC processing unit 160, and speakers 170. The microphone 120, the PC screen 130, the mouse 140, the keyboard 150, and the speakers 170 each interface to the PC processing unit 160. The PC processing unit 160 includes an installed promotional software application 190 for promoting branded products and/or services to a user of the PC system 100.

In accordance with alternative embodiments of the present invention, not all of the elements of the PC system 100 described above are included. For example, the microphone 120 and the mouse 140 may not be included in certain embodiments. Also, certain embodiments of the PC system 100 may include additional elements not specifically described herein. For example, it is well known that certain PC systems may include a hard drive and a compact disc drive. Also, it is well known that certain PC systems may include a wireless communication circuit to, for example, wirelessly connect to a network.

The promotional software application 190 provides and displays the animated character 115 on the desktop 110 when the promotional software application 190 is run on the PC system 100. The PC processing unit 160 also includes other installed software applications 180 such as, for example, an electronic mail application, an instant messaging application, an address book application, a notepad application, and a browser application.

In accordance with an embodiment of the present invention, the promotional software application 190 uses the Microsoft® Agent software technology as a foundation.

In accordance with various embodiments of the present invention, other PC systems can be employed as well including wireless and hand-held PC systems (e.g., a wireless personal digital assistant (PDA) in communication with the Internet). In accordance with an embodiment of the present invention, the PC system 100 comprises an off-the-shelf, commercially available PC system having off-the-shelf, commercially available other software applications 180 installed.

In accordance with various embodiments of the present invention, the term “character” as used herein can mean any graphical or photographic character representing a person, place, or thing. For example, a character may include a computer generated, drawn, or photographic image of a person, an animal, or a normally inanimate object such as a movie theatre ticket. Many other characters are possible as well. Similarly, in accordance with various embodiments of the present invention, the term “animated” as used herein to refer to the term “character” can mean simply that the character is computer generated, drawn, or photographed and does not move and/or talk, or can mean that the character also moves and/or talks.

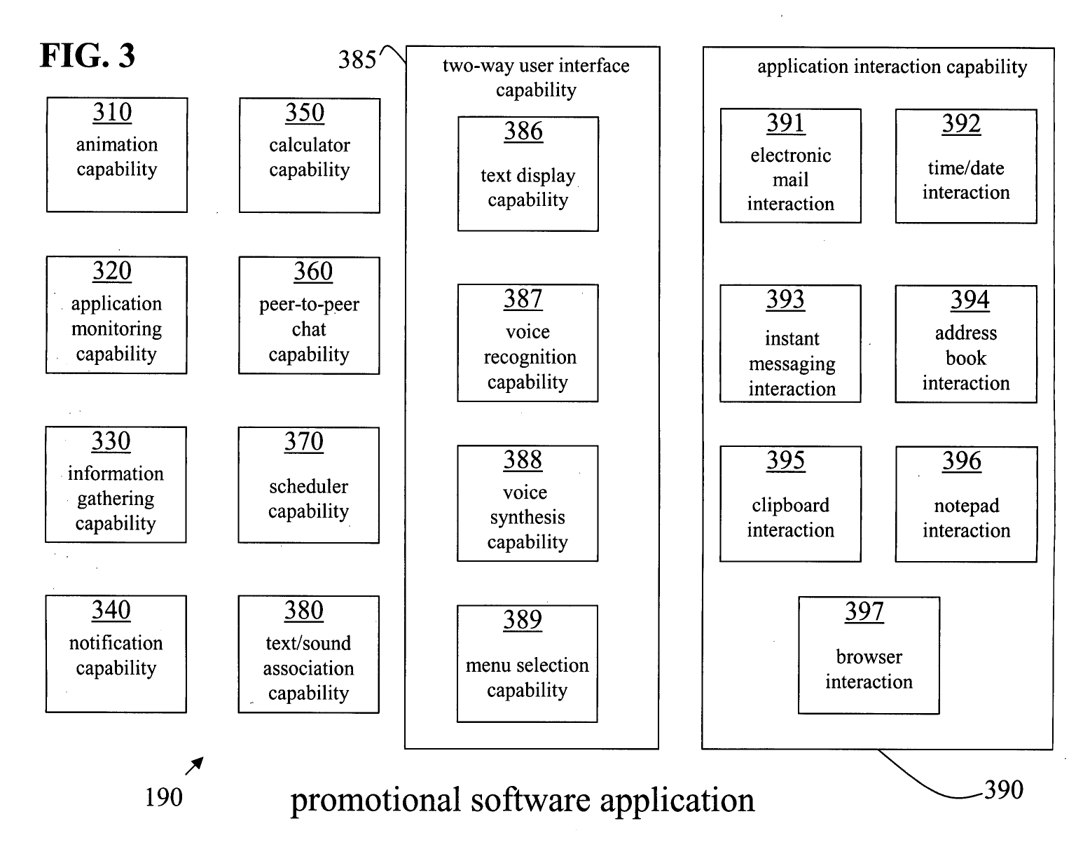

FIG. 3 illustrates a functional schematic block diagram of an embodiment of the promotional software application 190 installed on the personal computer system 100 of FIG. 1, in accordance with various aspects of the present invention. The promotional software application 190 comprises a plurality of functional capabilities including an animation capability 310, an application monitoring capability 320, an information gathering capability 330, a notification capability 340, a calculator capability 350, a peer-to-peer chat capability 360, a scheduler capability 370, a text/sound association capability 380, a two-way user interface capability 385, and an application interaction capability 390.

In accordance with alternative embodiments of the present invention, not all of the elements of the promotional software application 190 described above are included. For example, the text/sound association capability 380 may not be included in certain embodiments and the scheduler capability 370 may not be included in certain other embodiments. Also, certain embodiments of the promotional software application 190 may include additional elements not specifically described herein. For example, certain embodiments may include a custom dictation capability.

The two-way user interface capability 385 includes a text display capability 386, a voice recognition capability 387, a voice synthesis capability 388, and a menu selection capability 389. The application interaction capability 390 provides interaction of the promotional software application 190 with the other software applications 180. For example, in accordance with an embodiment of the present invention, the application interaction capability 390 provides electronic mail interaction 391, time/date interaction 392, instant messaging interaction 393, address book interaction 394, clipboard interaction 395, notepad interaction 396, and browser interaction 397.

In accordance with alternative embodiments of the present invention, the two-way user interface capability 385 may not include certain elements described above. For example, the voice recognition capability 387 may not be included in certain embodiments. Also, certain embodiments of the two-way user interface capability 385 may include additional elements not specifically described herein. For example, certain embodiments may include a touch-screen capability.

Similarly, in accordance with alternative embodiments of the present invention, the application interaction capability 390 may not include certain elements described above. For example, the instant messaging interaction 393 may not be included in certain embodiments. Also, certain embodiments of the application interface capability 390 may include additional elements not specifically described herein. For example, certain embodiments may include a spreadsheet interaction.

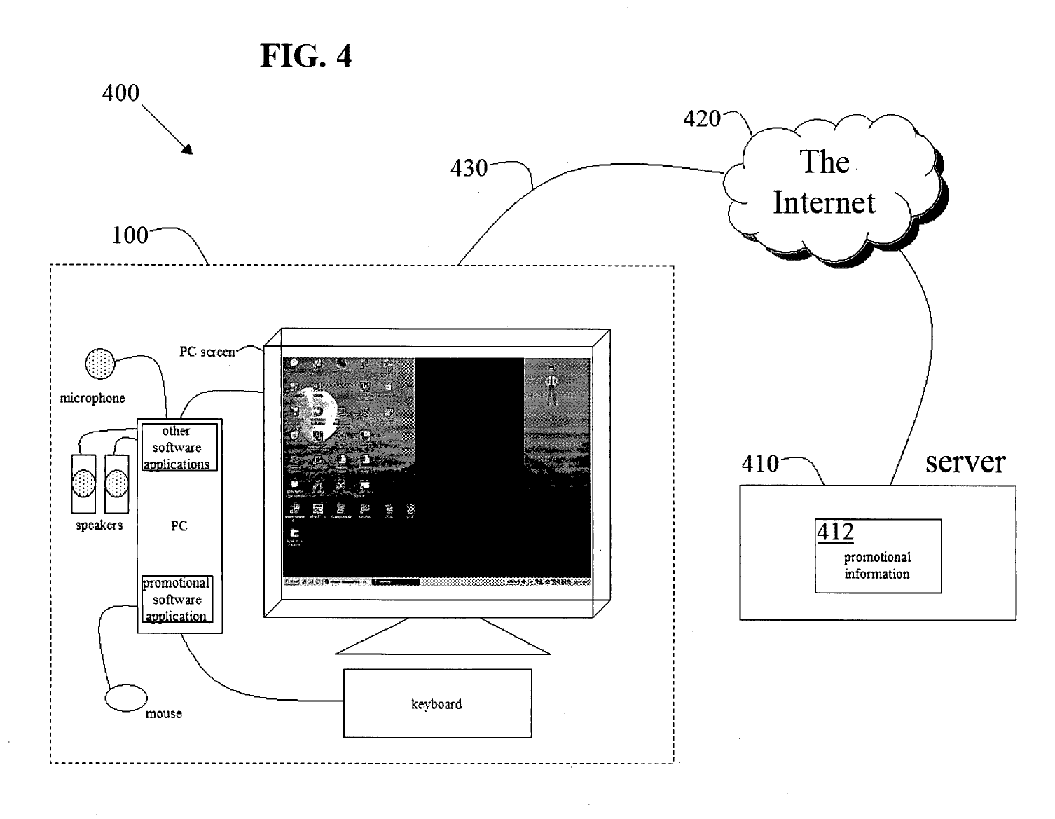

FIG. 4 illustrates a schematic block diagram of an exemplary embodiment of a first system 400 which includes the personal computer system 100 of FIG. 1, in accordance with various aspects of the present invention. The system 400 comprises a computer-based networked system 410 (e.g., a server) and a global informational network 420 (e.g., the Internet) connected between the PC system 100 and the server 410. The connection 430 between the PC 100 and the Internet 420 is accomplished via, for example, a dial up connection or a cable modem connection. The server 410 hosts promotional information 412 in digital form.

In accordance with an embodiment of the present invention, the promotional software application 190 and the server 410 are provided by a promotional service provider. The promotional information 412 is provided to the promotional service provider by a client (i.e., a business entity) of the promotional service provider who desires to promote his branded products and/or services. The client can provide periodic updates or variations of content of the promotional information 412 such that the updates are placed on the server 410 by the promotional service provider.

In accordance with various embodiments of the present invention, the promotional information 412 may include at least one of sale information, coupons, special offers, educational or informational materials, surveys, and contests. Other types of promotional information are possible as well. In accordance with an embodiment of the present invention, data mining techniques are used, based on user preferences, to gather only certain types of promotional information. In accordance with another embodiment of the present invention, business rules are implemented to create custom targeted marketing campaigns to users.

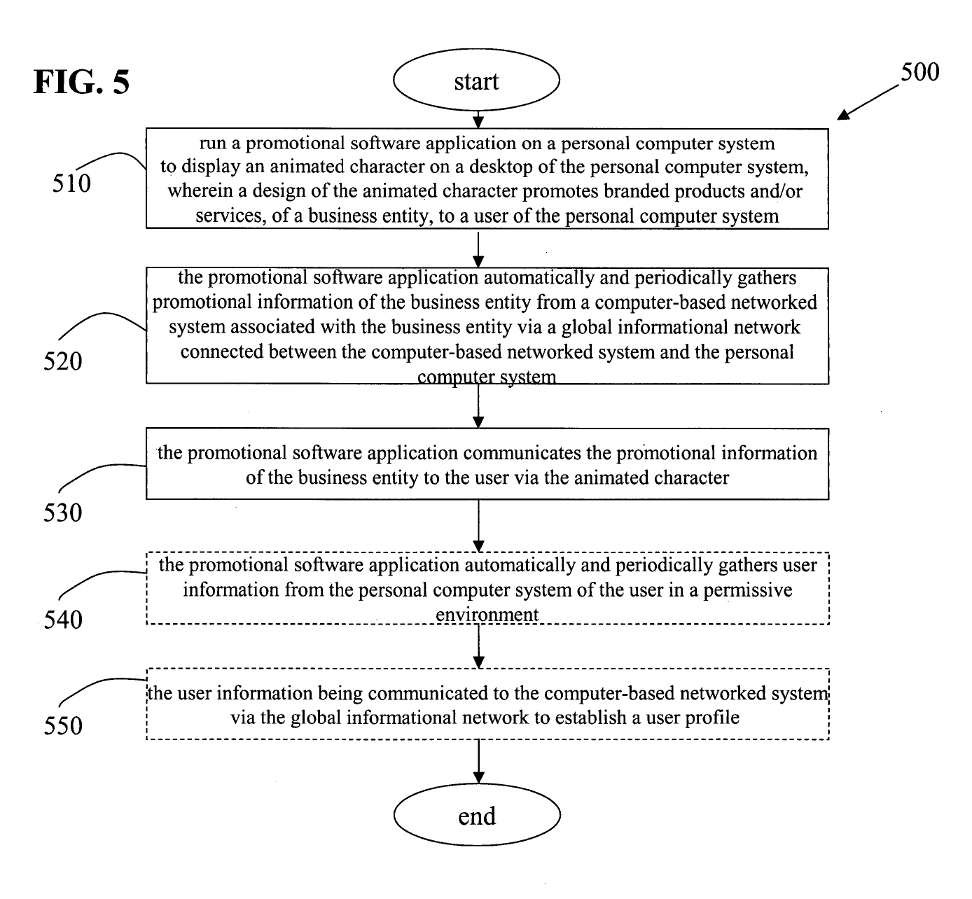

FIG. 5 is a flowchart of an embodiment of a method 500 to promote a business entity's branded products and/or services using the system 400 of FIG. 4, in accordance with various aspects of the present invention. In step 510, a promotional software application is run on a personal computer system to display an animated character on a desktop of the personal computer system, wherein a design of the animated character promotes branded products and/or services, of a business entity, to a user of the personal computer system. In step 520, the promotional software application automatically and periodically gathers promotional information of the business entity from a computer-based networked system associated with the business entity via a global informational network connected between the computer-based networked system and the personal computer system. In step 530, the promotional software application communicates the promotional information of the business entity to the user via the animated character.

In accordance with an embodiment of the present invention, the business entity comprises a client of the promotional service provider, and the computer-based networked system comprises a server. In accordance with an embodiment of the present invention, the animated character 115 is persistently (i.e., continuously) displayed on the desktop 110.

In accordance with an alternative embodiment of the present invention, the animated character 115 may be periodically, intermittently, or occasionally displayed on the desktop 110. For example, the animated character may only be displayed when the user of the PC system 100 specifically commands that the animated character 115 be displayed. As another example, the animated character 115 may only be displayed when the promotional service provider specifically commands, from the server 410, that the animated character 115 be displayed.

As an example, referring to FIG. 1 and FIG. 2, a user of the PC system 100 double clicks on an icon 101 on the desktop 110 to initiate the running of the promotional software application 190. As a result, the animated character 115 is displayed on the desktop 110 and greets the user with a standard or a customizable greeting that can contain the date and time. The greeting may be spoken in the voice of the animated character 115 using a voice synthesis capability of the promotional software application 190, appear in a text bubble, or both. The animated character 115 may be persistently (i.e., continuously) displayed on the desktop 110 or simply displayed periodically. The design of the animated character 115 promotes, for example, business casual clothing where the client is a clothing retailer. In accordance with an embodiment of the present invention, the step 510 of displaying the animated character 115 is performed by the animation capability 310 of the promotional software application 190 of FIG. 3. Any business entity may be represented with a unique animated character, in accordance with various aspects of the present invention.

Referring to FIG. 4, the promotional software application 190 accesses the server 410 via the Internet 420 and gathers the promotional information 412 such that the promotional information 412 is communicated to the PC system 100 via the Internet 420. The accessing of the server 410 and the gathering of the promotional information 412 is performed automatically by the promotional software application 190 without the user having to initiate such a step (i.e., the step 520 of the method 500 is transparent to the user). In accordance with an embodiment of the present invention, the information gathering capability 330 of the promotional software application 190 of FIG. 3 is used to perform step 520 of the method 500.

In accordance with alternative embodiments of the present invention, promotional information may be accessed by the promotional software application 190 from a hard drive of the PC system 100 or from a compact disc (CD) or digital video disc (DVD) in a drive of the PC system 100 (i.e., from a digital media disc), or from some other digital stored memory or digital data source (e.g., a memory stick)

Once the promotional information 412 is received by the PC system 100, the notification capability 340 of the promotional software application 190 is used to notify the user that the promotional information 412 has been received. Such notification is provided to the user via the animated character 115 in at least one of several ways including having the animated character 115 perform a unique animation, displaying a text bubble with a notification message, and having the animated character 115 speak to the user using synthesized audio speech to deliver a notification message.

For example, if the promotional software application 190 is configured to have the animated character 115 perform a unique animation, the notification capability 340 triggers a unique animation provided by the animation capability 310 when the promotional information 412 is received. Alternatively, if the promotional software application is configured to display a text bubble with a notification message, the notification capability 340 triggers the text display capability 386 of the two-way user interface capability 385 when the promotional information 412 is received. Similarly, if the promotional software application is configured to have the animated character 115 speak to the user using speech to deliver a notification message, the notification capability 340 triggers the voice synthesis capability 388 of the two-way user interface capability 385 when the promotional information 412 is received. Any combination of the notification methods can be configured as well.

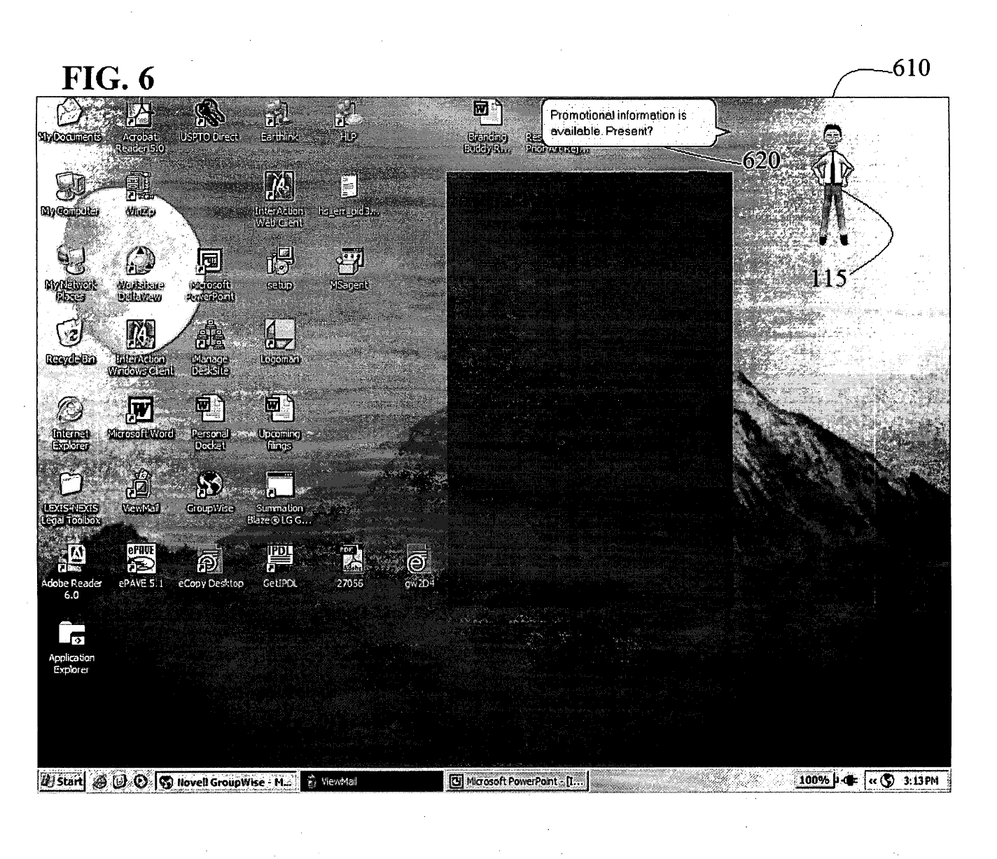

FIG. 6 illustrates an exemplary embodiment of a desktop view 610 using an animated character 115 to communicate a notification message via a text bubble 620, in accordance with various aspects of the present invention. The text bubble 620, in this example, notifies the user that promotional information 412 is available and asks the user if he would like to be presented with the promotional information 412. The user may affirm to the promotional software application 190, via the two-way user interface capability 385, that the user desires to have the promotional information 412 presented (i.e. communicated) to him.

For example, the user may speak an audible voice command (e.g., “Present”) into the microphone 120 such that the voice recognition capability 388 generates a voice-activated command that is recognizable to the promotional software application 190 and initiates communication of the promotional information 412 to the user. Alternatively, the user can click on the text bubble 620 or the animated character to initiate communication of the promotional information 412. In accordance with an embodiment of the present invention, the voice recognition capability 388 is activated by pressing a certain predefined key on the keyboard 150, for example. When the key is pressed, the user has, for example, 10 seconds to speak an audible voice command into the microphone 120.

As a result, in step 530 of the method 500, the promotional information 412 is communicated to the user, via the animated character 115, using at least one of the text display capability 386, the voice synthesis capability 388, and the animation capability 310. For example, when the text display capability 386 is used, the promotional information 412 is converted to text, if necessary, and displayed to the user in the text bubble 620 on the desktop 610. The text bubble 620 is displayed to appear as if the animated character 115 is communicating the promotional information 412. If the voice synthesis capability 388 is used, the promotional information 412 is converted to audio speech and played to the user via the speakers 170. In either case, the animation capability 310 can be used to make the animated character 115 perform animated motions and present animated graphics associated with the promotional information 412 being communicated.

In accordance with various embodiments of the present invention, the promotional information 412 may include coupons that can be printed out and used at the client's facility. Also, the promotional information 412 may include a survey that can be filled out by the user on the PC system 100 and sent back to the server 410. Furthermore, the promotional information 412 may include a contest that the user can enter or play on the PC system 100. The animated character 115 can present these various forms of promotional information 412 to the user on the desktop 110 using any of the various text, animation/graphical, and voice synthesis capabilities previously discussed.

When the promotional software application 190 is not using the animated character 115 to perform any specific function (i.e., the promotional software application 190 is relatively idle), the promotional software application 190 may command the animated character 115 to perform entertaining animations using the animation capability 310, in accordance with an embodiment of the present invention.

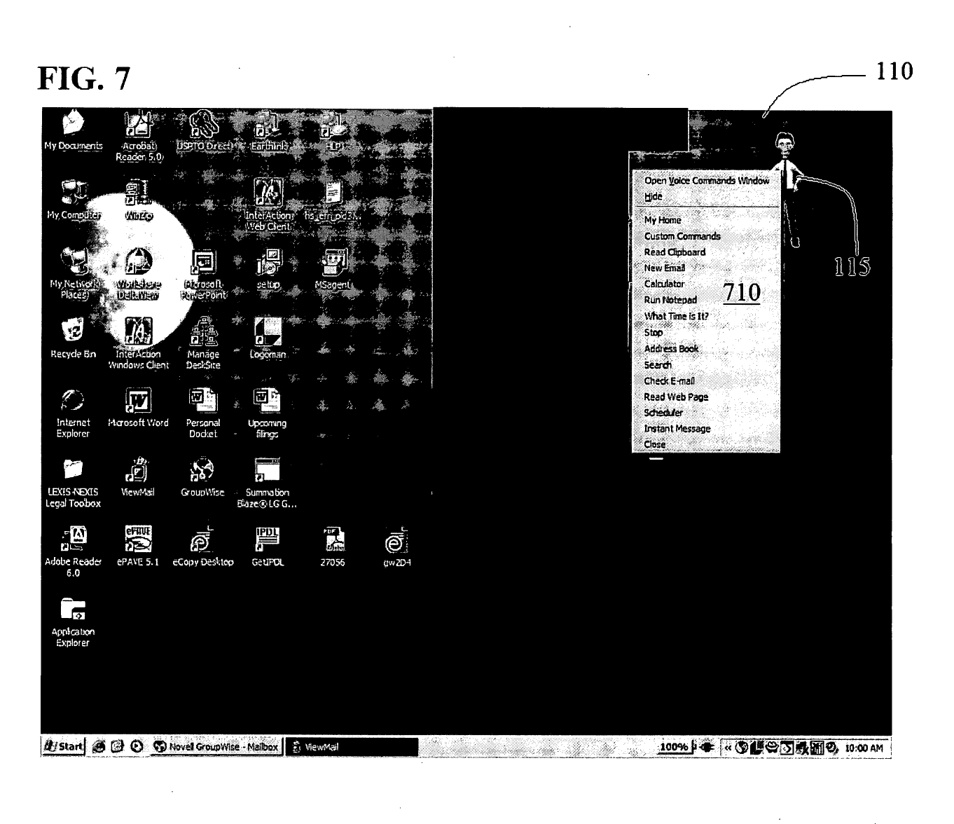

FIG. 7 illustrates an exemplary embodiment of a drop-down menu 710 that is displayed on the desktop 110 of FIG. 1, in accordance with various aspects of the present invention. When the user right clicks, using the mouse 140, on the animated character 115, the menu selection capability 389 of the two-way user interface capability 385 causes the drop-down menu 710 to be displayed. As a result, the user can select from a plurality of menu options.

In accordance with an embodiment of the present invention, the menu options may include “Open Voice Commands Window”, “Hide”, “My Home” (this may actually be the web address of the client), “Custom Commands”, “Read Clipboard”, “New Email”, “Calculator”, “Run Notepad”, “What Time is It?”, “Stop”, “Address Book”, “Search”, “Check E-mail”, “Read Web Page”, “Scheduler”, “Instant Message”, “Download Music”, and “Close”. The functions of each of these menu options are discussed below.

In accordance with alternative embodiments of the present invention, not all of the menu option elements described above may be included in the drop-down menu 710.

When a user selects the “Open Voice Commands Window” menu option, a list of voice commands is displayed which can be audibly spoken by the user into the microphone to activate a function or capability via the voice recognition capability 387. In accordance with an embodiment of the present invention, the list of voice commands includes commands to activate the various drop-down menu functions (e.g., “My Home”, “Custom Commands”, “Read Clipboard”, “New Email”, “Calculator”, “Run Notepad”, “What Time is It?”, “Stop”, “Address Book”, “Search”, “Check E-mail”, “Read Web Page”, “Scheduler”, “Instant Message”. That is, certain drop-down menu commands may be activated by voice commands as well as by selecting from the drop-down menu. Other voice-activated commands are possible as well, in accordance with various embodiments of the present invention.

The “Hide” option, when selected (e.g., by drop-down menu or voice activation), hides the animated character 115 and leaves the client's logo in the system tray of the desktop view 110. The “My Home” option, when selected, launches a browser application (i.e., one of the other software applications 180) using the browser interaction capability 397 and accesses a home web page of the client. The “Custom Commands” option, when selected, allows the user to customize the voice recognition parameters and the voice synthesis parameters associated with the voice recognition capability 387 and the voice synthesis capability 388. For example, a speed at which the animated character speaks may be adjusted.

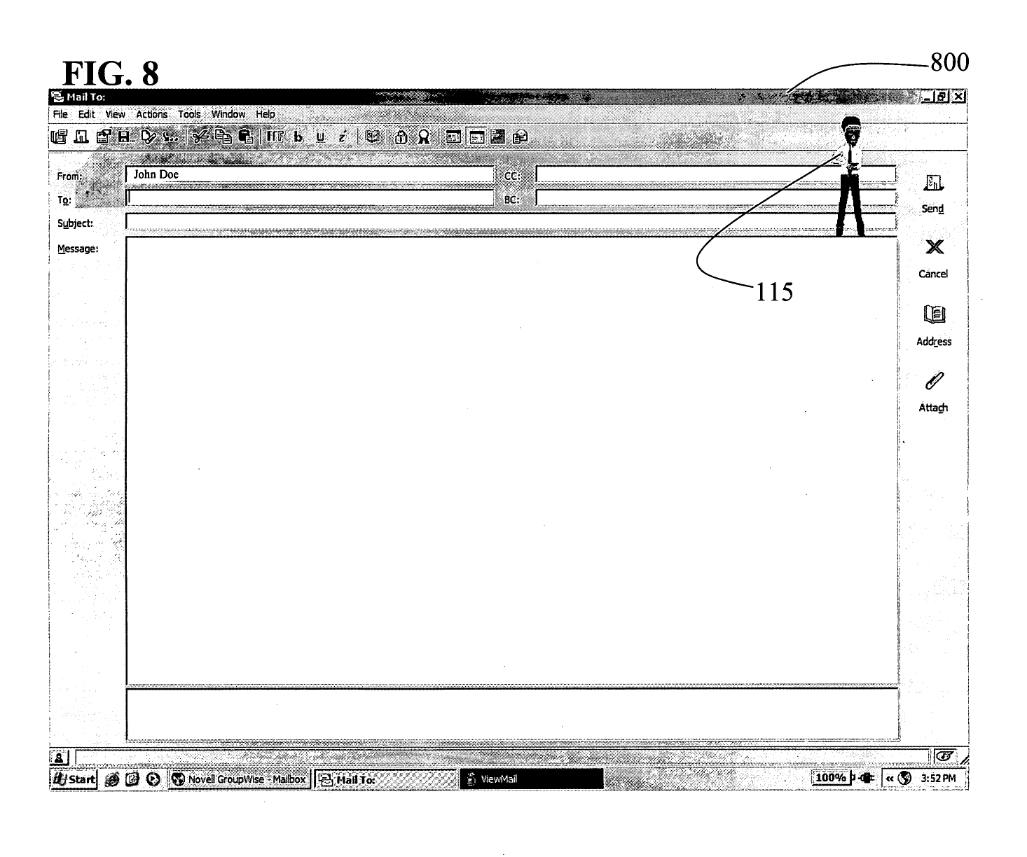

The “Read Clipboard” option, when selected, reads whatever text may be saved to the clipboard of the PC system 100 in character voice using the clipboard interaction capability 395 and the voice synthesis capability 388. The “New Email” option, when selected, causes interaction with an email application (i.e., one of the other software applications 180) using the electronic mail interaction capability 391 such that a user may begin drafting a new email message to be sent to others. FIG. 8 illustrates an exemplary embodiment of a new email view 800 that is displayed to the user on the PC screen 130 when the “New Email” option is selected, in accordance with various aspects of the present invention. A user may draft and send a new email message as normal. Notice that the animated character 115 is still displayed to the user. In general, whenever a user opens a software application 180 or accesses a web page on the Internet 201, the animated character 115 is still displayed to the user.

The “Calculator” option, when selected, causes the calculator capability 350 (i.e., a customized calculator sub-application of the promotional software application 190) to activate and display a functional calculator to the user on the PC screen 130. The design of the displayed calculator promotes at least one branded product and/or service of the client or an affiliated brand or a customer of the client. The user may use the mouse 140 and or keyboard 150 to interact with the displayed calculator to perform various types of arithmetical and mathematical calculations.

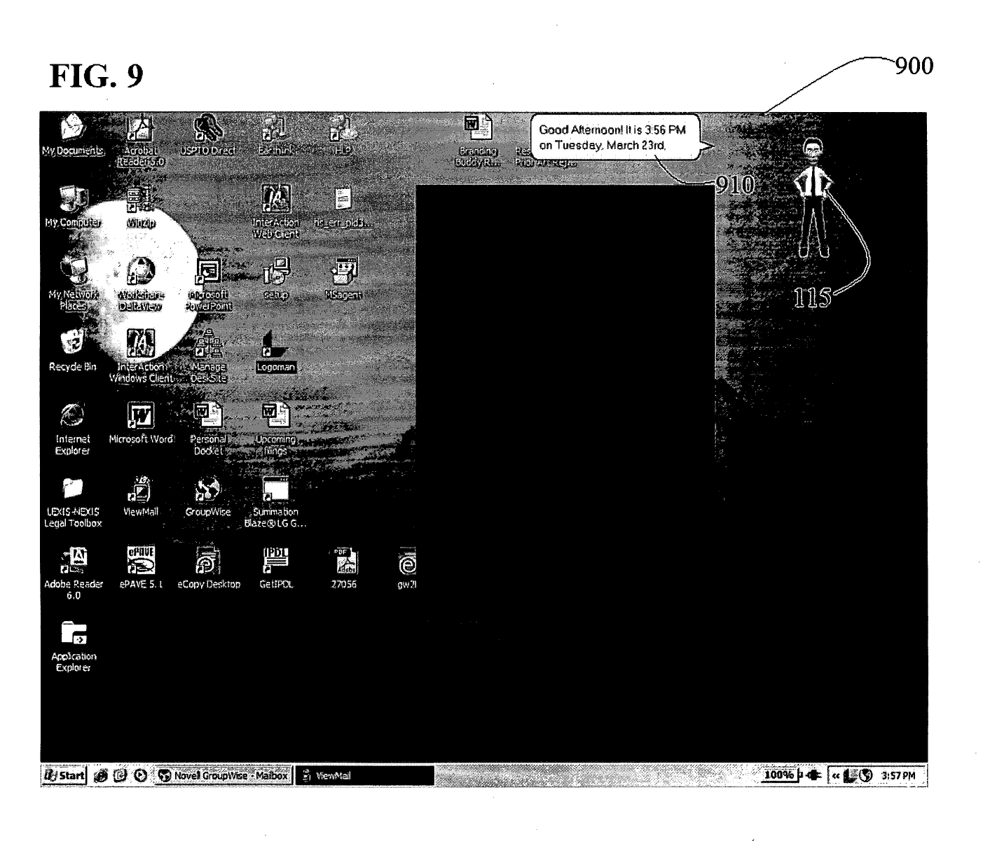

The “Run Notepad” option, when selected, causes interaction with an notepad application (i.e., one of the other software applications 180) using the notepad interaction capability 391 such that a user may enter text into a notepad text window and save the entered text as a notepad text file. The “What Time is It?” option, when selected, causes the time/date interaction capability 392 to access the current time and date from a system clock of the PC system 100 and display the accessed time and date in a text bubble using the text display capability 386. As an alternative, the accessed time and date is read to the user in the synthesized voice of the animated character 115 using the voice synthesis capability 388. FIG. 9 illustrates an exemplary embodiment of the animated character 115 announcing the time and date in a text bubble 910 on a desktop view 900, in accordance with various aspects of the present invention.

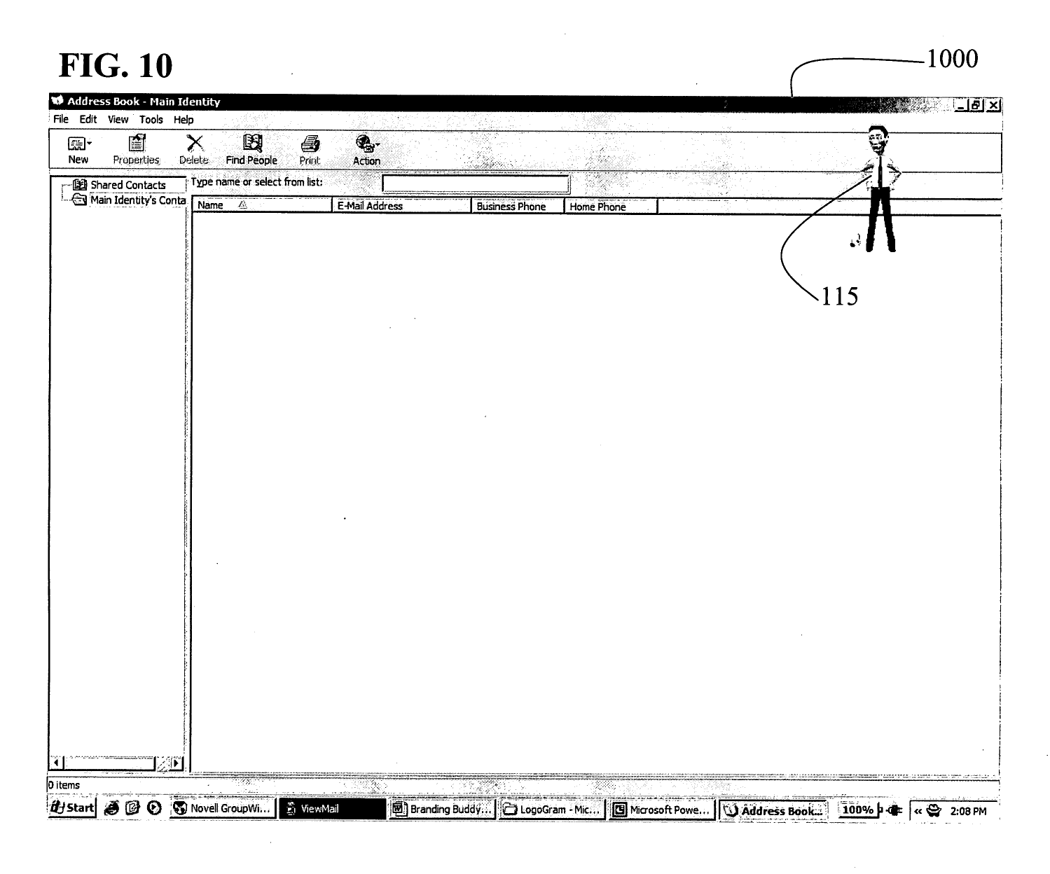

The “Stop” option, when selected, will stop the animated character from reading text from the clipboard if the animated character is in the process of reading text from the clipboard (i.e., the clipboard interaction capability 395 is terminated along with the text display capability 386 and/or the voice synthesis capability 388 being used to convey the text information on the clipboard). The “Address Book” option, when selected, causes interaction with an address book application (i.e., one of the other software applications 180) using the address book interaction capability 394 such that a user may access address information of, for example, business associates, friends, or family members. FIG. 10 illustrates an exemplary embodiment of an address book view 1000 that is displayed to the user on the PC screen 130 of FIG. 1 when the “Address Book” option is selected, in accordance with various aspects of the present invention.

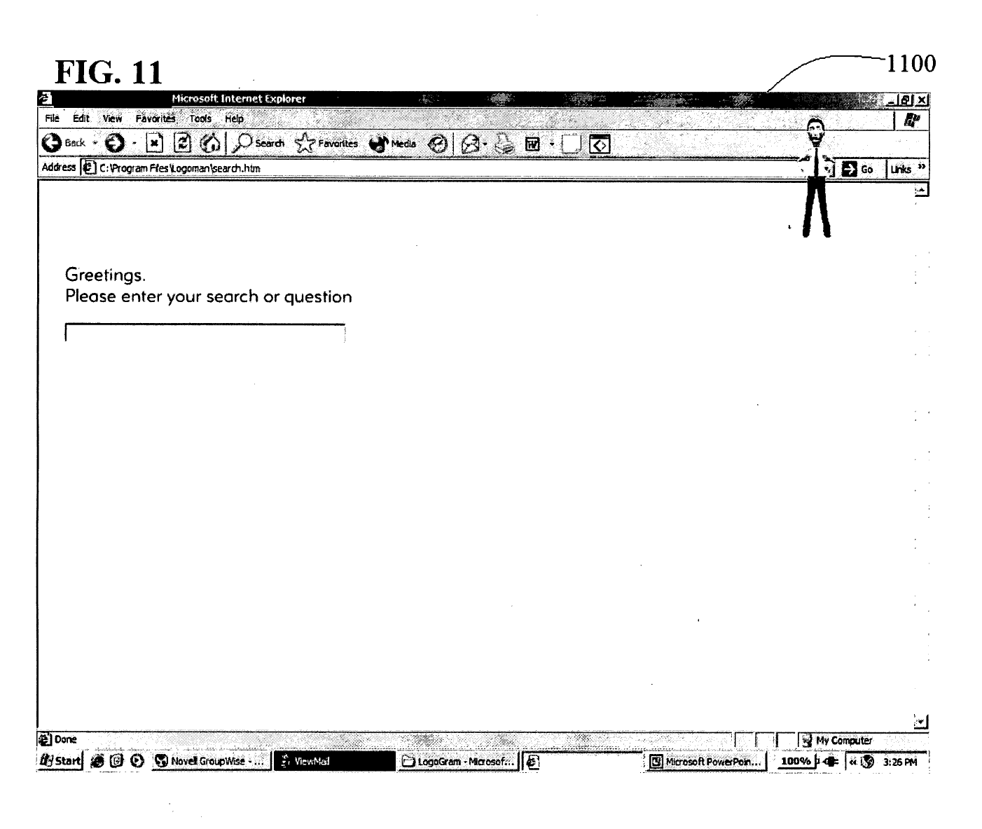

The “Search” option, when selected, launches a browser application (i.e., one of the other software applications 180) using the browser interaction capability 397 and accesses a search web page of the business entity that allows the user to input search terms to search the business entity's database server for information. FIG. 11 illustrates an exemplary embodiment of a search view 1100 that is displayed to the user on the PC screen 130 of FIG. 1 when the “Search” option is selected, in accordance with various aspects of the present invention.

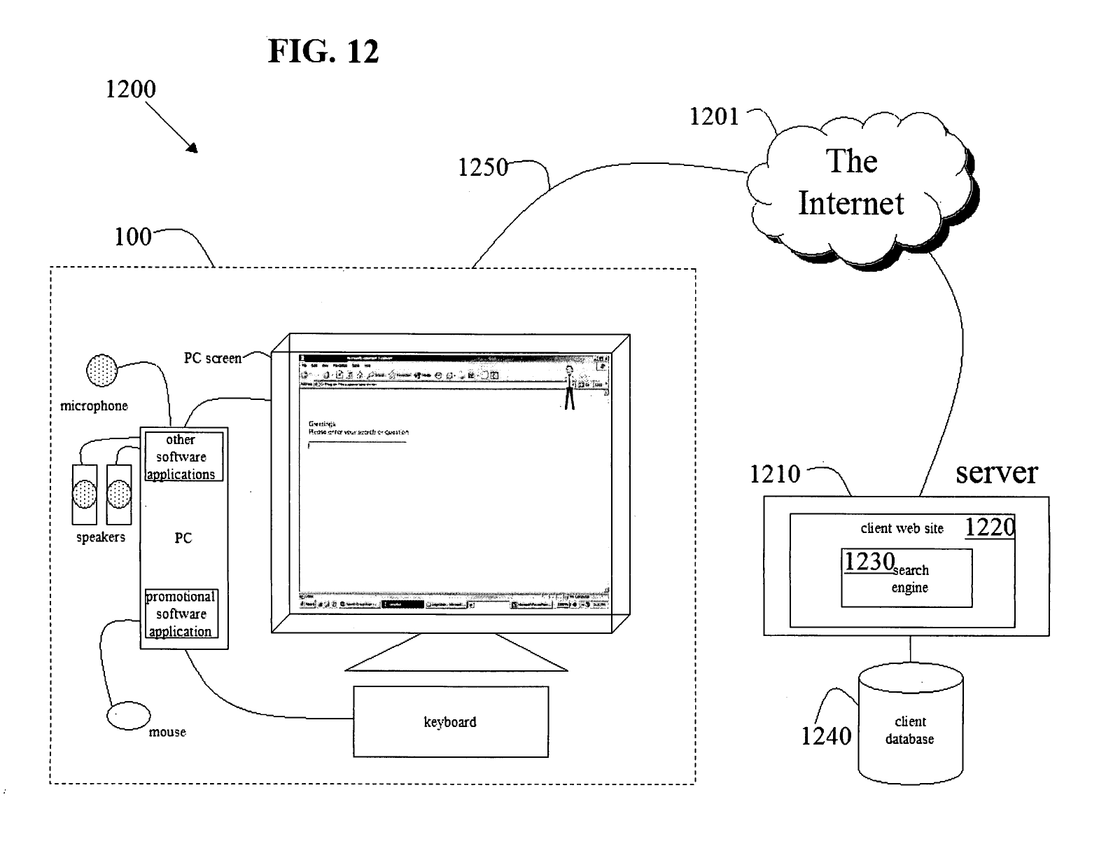

FIG. 12 illustrates a schematic block diagram of an exemplary embodiment of a second system 1200 which includes the personal computer system 100 of FIG. 1, in accordance with various aspects of the present invention. The system 1200 comprises a computer-based networked system 1210 (e.g., server) hosting a business entity's (e.g., a client's) search web site 1220 which uses a search engine 1230. The server 1210 is connected to a client database 1240 which stores client information that is accessible by using the search engine 1230 via the web site 1220. The system further comprises a global informational network 1201 (e.g., the Internet) connected between the PC system 100 and the server 1210 to allow a user of the PC system 100 to access the client information from the client database 1240. The connection 1250 between the PC system 100 and the Internet 1201 is accomplished, for example, via a dial up connection or a cable modem connection, in accordance with various embodiments of the present invention.

The “Check E-mail” option, when selected, causes interaction with an email application (i.e., one of the other software applications 180) using the electronic mail interaction capability 391 such that the user's new email messages are presented to the user via either a text bubble using the text display capability 386 and/or the character voice using the voice synthesis capability 388 (i.e., the animated character “reads” email messages to the user).

The “Read Web Page” option, when selected, launches a browser application (i.e., one of the other software applications 180) using the browser interaction capability 397 and accesses a home web page of the user or designated home page of the client. The user may access other web pages by clicking on links, or access other web sites by typing in URL addresses or clicking on links in the “Favorites” window, for example. In accordance with an embodiment of the present invention, when the user uses the mouse 140 to point to text on a displayed web page, the animated character 115 will “read” the text in character voice to the user using the voice synthesis capability 388 and the speakers 170.

The “Scheduler” option, when selected, causes the scheduler capability 370 (i.e., a customized scheduler sub-application of the promotional software application 190) to activate and display a functional calendar-based scheduler to the user on the PC screen 130. The design of the displayed scheduler promotes at least one branded product and/or service of the client or client's customer. The user may use the mouse 140 and or keyboard 150 to interact with the displayed scheduler to enter appointments and meetings, for example. The scheduler can also be updated by a server application on the global informational network.

The “Instant Message” option, when selected, causes interaction with an instant messaging application (i.e., one of the other software applications 180) using the instant messaging interaction capability 391 such that the user's incoming instant messages are presented to the user via the character voice using the voice synthesis capability 388 and speakers 170 (i.e., the animated character “reads” the instant message to the user). Similarly, a user may use the microphone 120 and the voice recognition capability 387 to construct an instant message to be sent when using the “Instant Message” option. Alternatively, incoming instant messages are displayed in a text bubble associated with the animated character 115 and outgoing instant messages are typed in by the user using the keyboard 150.

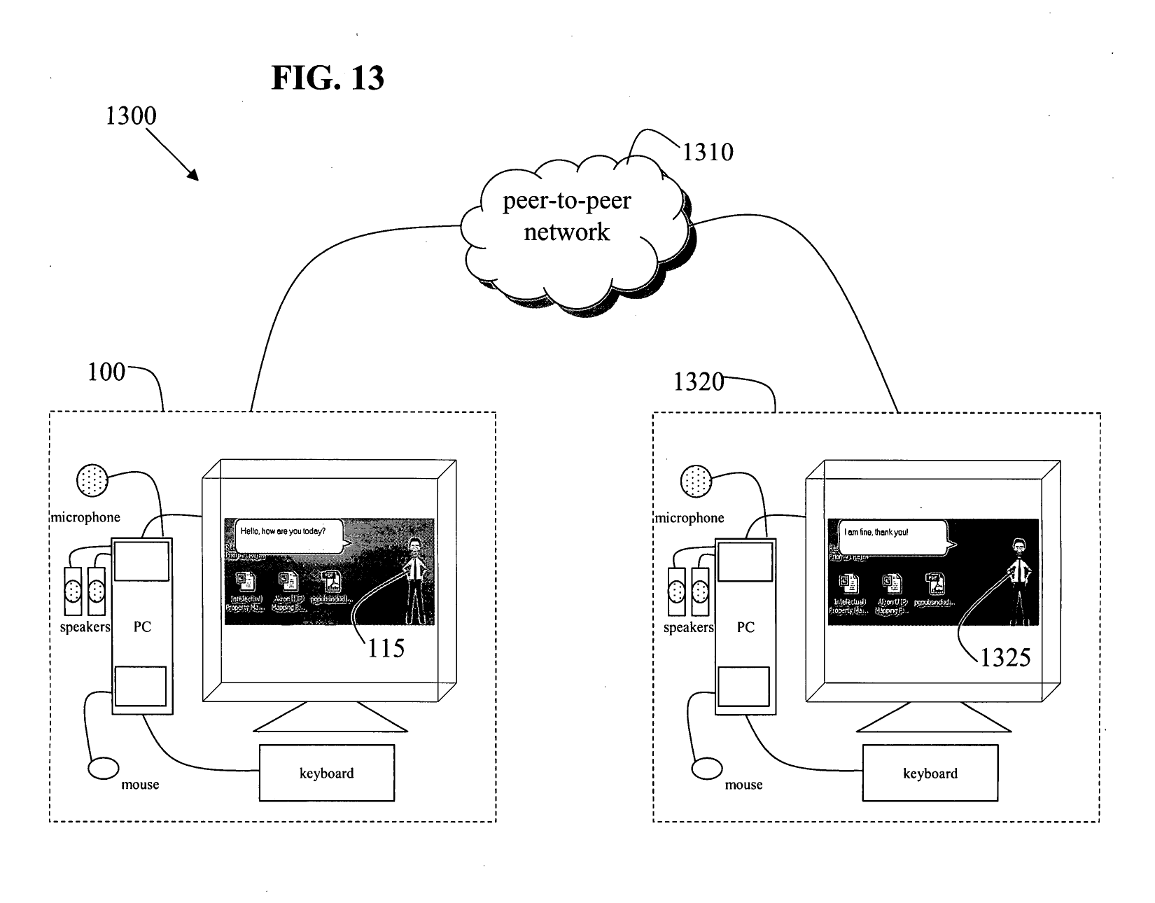

FIG. 13 illustrates a schematic block diagram of an exemplary embodiment of a third system 1300 which includes the personal computer system 100 of FIG. 1, in accordance with various aspects of the present invention. The system 1300 includes a peer-to-peer network 1310 connected between a first PC system 100 and a second PC system 1320. The peer-to-peer network 1310 is a network that does not use a central computer or a dedicated server. In a peer-to-peer network, every computer acts on its own and is not dependent on another computer or server to, for example, exchange files or instant messages. Using the peer-to-peer chat capability 360, a user of the PC system 100 can communicate, via his animated character 115, with the user of the PC system 1320 using her animated character 1325 via-the peer-to-peer network 1310. The peer-to-peer chat capability 360 is a customized sub-application of the promotional software application 190.

The “Close” option, when selected, closes the promotional software application 190, causing the animated character 115 to no longer be displayed on the desktop 110. The functional capability provided by the promotional software application 190 becomes inoperable until the user once again opens the promotional software application by double clicking on the icon 101 (see FIG. 2).

Other user selectable drop-down menu and/or voice-activated options are possible as well. For example, a “Word/Sound Association” option and capability could be provided to allow a user to associate verbal output to a written word (e.g., to allow phonetic spelling to ensure that a client's name is pronounced correctly by the animated character 115 using the voice synthesis capability 388). The text/sound association capability 380 provides such association functionality. Similarly, images of products can be associated with certain sounds. An image of a product is displayed on the PC screen 130 when the user and/or the animated character 115 makes a certain sound. As a further option, custom weather information is provided to the user via the animated character based on client preferences, for example.

Also, a “Stop Animation” option may be provided which allows the user to temporarily suspend the moving animations of the character. A “Silent/Quiet” option may be provided which allows the user to temporarily suspend the use of the sound or speech module. In both cases the animated character still remains on the desktop.

In accordance with an embodiment of the present invention, the promotional software application 190 uses the application monitoring capability 320 to monitor certain other software applications 180 for a change in state. For example, the application monitoring capability 320 monitors an email application for incoming email messages and/or an instant messaging application for incoming instant messages. When the application monitoring capability 320 detects an incoming message (i.e. a change in state of the monitored application), the notification capability 340 is activated to notify the user that an incoming message (e.g., email message or instant message) has been received. Such notification is provided to the user via the animated character 115 in at least one of several ways including having the animated character 115 perform a unique animation, displaying a text bubble with a notification message, and having the animated character 115 speak to the user using synthesized audio speech to deliver a notification message.

In accordance with an optional embodiment of the present invention, the promotional software application 190 automatically and periodically gathers user information from the personal computer system 100 of the user, in a permissive environment (see step 540 of FIG. 5). The user information may be stored on the personal computer system and/or automatically communicated from the personal computer system 100 to the computer-based networked system (e.g., 410 or 1210, a server) via the global informational network 420 (e.g., the Internet) (see step 550 of FIG. 5).

When the user information is stored on the personal computer system 100, it may be accessed at a later time by, for example, the client or the promotional service provider via automatic or manual means. For example, the user information may be periodically uploaded from the personal computer system 100 to the server 1210 by the business entity (i.e., client). When the user information is automatically communicated to the computer-based networked system (e.g., 410 or 1210), the user information is stored on the computer-based networked system (e.g., 410 or 1210). The user information is used to generate a complex user/consumer profile that outlines user buying habits, user likes/dislikes, user demographic information, etc.

Such user information is collected as part of an opt-in business method with the user's full knowledge. No information is collected or tracked covertly. As an alternative, the user information may be manually input by the user via the personal computer system 100 to the promotional software application 190.

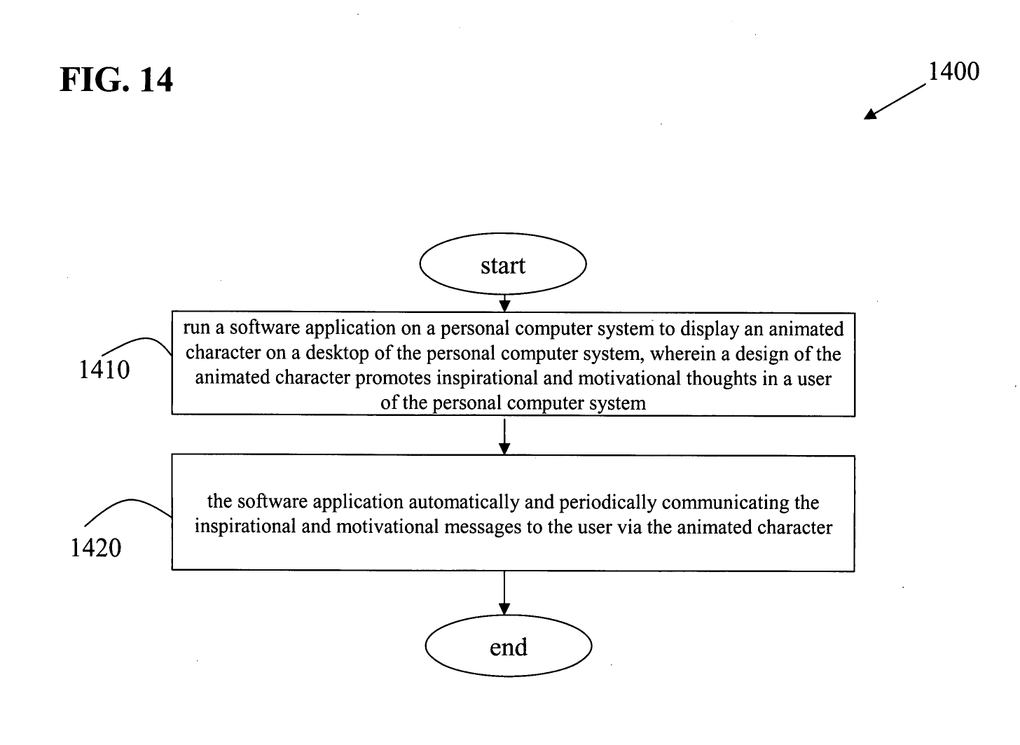

FIG. 14 illustrates a flowchart of an embodiment of a method 1400 to provide inspirational and motivational messages, in accordance with various aspects of the present invention. The method includes, in step 1410, running a software application on a personal computer system to display an animated character on a desktop of the personal computer system. A design of the animated character promotes inspirational and motivational thoughts in a user of the personal computer system. The method further includes, in step 1420, the software application automatically and periodically communicating the inspirational and motivational messages to the user via the animated character.

The software application may be provided to the user by a business entity for a fee, for example. The user installs and initiates running of the software application on the personal computer system. Again, the animated character may be persistently or intermittently displayed on the desktop of the personal computer system. As described previously, the software application may interact with other software applications installed on the personal computer system and may monitor other software applications for a change in state. Also, the software application may comprise other sub-applications that can be launched in response to a command from the user of the personal computer system.

The software application provides various capabilities including a speech synthesis capability, a displayed text capability, specific animations of the animated character, and other graphical display capabilities to communicate the inspirational and motivational messages to the user via the animated character, in accordance with an embodiment of the present invention.

In summary, a method to promote a business entity's branded products and/or services using a promotional software application is disclosed. The promotional software application provides an animated character that a user may interact with on a desktop of the user's personal computer system to perform various useful functions. The promotional software application automatically provides promotional information from the business entity to the user on the user's personal computer system when the promotional information becomes available on, for example, a server of a promotional service provider.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method to promote a business entity's branded products and/or services, said method comprising:
running a promotional software application on a personal computer system to display an animated character on a desktop of said personal computer system, wherein a design of said animated character promotes branded products and/or services, of a business entity, to a user of said personal computer system;
said promotional software application automatically and periodically gathering promotional information of said business entity from a computer-based networked system associated with said business entity via a global informational network connected between said computer-based networked system and said personal computer system; and
said promotional software application communicating said promotional information of said business entity to said user via said animated character.

2. The method of claim 1 wherein said promotional software application is provided to said user by a promotional service provider.

3. The method of claim 2 wherein said business entity comprises a client of said promotional service provider.

4. The method of claim 1 wherein said promotional software application is installed on said personal computer system by said user.

5. The method of claim 1 wherein said running of said promotional software application on said personal computer system is initiated by said user.

6. The method of claim 1 wherein said computer-based networked system comprises a server.

7. The method of claim 1 wherein said animated character is displayed persistently on said desktop.

8. The method of claim 1 further comprising said promotional software application automatically and periodically gathering user information from said personal computer system of said user, in a permissive environment.

9. The method of claim 8 further comprising said user information being communicated to said computer-based networked system via said global informational network to establish a user profile outlining at least user buying habits, user likes and dislikes, and user demographic information.

10. The method of claim 1 further comprising said promotional software application interacting with at least one other software application installed on said personal computer system when said user of said personal computer system initiates said interaction.

11. The method of claim 1 further comprising said promotional software application monitoring at least one other software application running on said personal computer system for at least one change in state of said at least one other software application.

12. The method of claim 1 further comprising said promotional software application launching a sub-application of said promotional software application in response to a command from said user.

13. The method of claim 1 further comprising said promotional software application notifying said user, via said animated character, that said promotional information is available.

14. The method of claim 1 wherein said promotional information is communicated to said user via said animated character through said personal computer system using at least one of a speech synthesis capability of said promotional software application, a displayed text capability of said promotional software application, specific animations of said animated character, and other displayed graphics provided by said promotional software application.

15. The method of claim 1 further comprising said promotional software application responding to a selected menu command or to a voice-activated command of said user, using a voice recognition capability of said promotional software application, by interacting with an electronic mail application on said personal computer system to access and present an electronic mail message to said user via said animated character using a synthesized audio speech capability and/or a text display capability of said promotional software application.

16. The method of claim 1 further comprising said promotional software application responding to a selected menu command or to a voice-activated command of said user, using a voice recognition capability of said promotional software application, by interacting with an instant messaging application on said personal computer system to access and present an instant messaging message to said user via said animated character using a synthesized audio speech capability and/or a text display capability of said promotional software application.

17. The method of claim 1 further comprising said promotional software application responding to a selected menu command or to a voice-activated command of said user, using a voice recognition capability of said promotional software application, by interacting with a clipboard application on said personal computer system to access and present text stored in said clipboard to said user via said animated character using a synthesized audio speech capability and/or a text display capability of said promotional software application.

18. The method of claim 1 further comprising said promotional software application responding to a selected menu command or to a voice-activated command of said user, using a voice recognition capability of said promotional software application, by interacting with an address book application on said personal computer system to launch said address book application and to display a functional user interface of said address book application to said user on said personal computer system.

19. The method of claim 1 further comprising said promotional software application responding to a selected menu command or to a voice-activated command of said user, using a voice recognition capability of said promotional software application, by interacting with a browser application on said personal computer system to launch said browser application and to display a functional user interface of said browser application to said user on said personal computer system.

20. The method of claim 1 further comprising said promotional software application responding to a selected menu command or to a voice-activated command of said user, using a voice recognition capability of said promotional software application, by interacting with an electronic mail application on said personal computer system to initiate drafting of a new electronic mail message by said user.

21. The method of claim 1 further comprising said promotional software application responding to a selected menu command or to a voice-activated command of said user, using a voice recognition capability of said promotional software application, by launching a calculator sub-application of said promotional software application on said personal computer system and displaying a functional user interface of said calculator sub-application to said user on said personal computer system.

22. The method of claim 1 further comprising said promotional software application responding to a selected menu command or to a voice-activated command of said user, using a voice recognition capability of said promotional software application, by interacting with a system clock on said personal computer system to access and present a current time and/or date to said user via said animated character using a synthesized audio speech capability and/or a text display capability of said promotional software application.

23. The method of claim 1 further comprising said promotional software application responding to a selected menu command or to a voice-activated command of said user, using a voice recognition capability of said promotional software application, by interacting with a browser application on said personal computer system to launch said browser application and to access a web site of said business entity using said browser application.

24. The method of claim 1 further comprising said promotional software application responding to a selected menu command or to a voice-activated command of said user, using a voice recognition capability of said promotional software application, by launching a scheduler sub-application of said promotional software application on said personal computer system and displaying a functional user interface of said scheduler sub-application to said user on said personal computer system.

25. The method of claim 1 further comprising said promotional software application responding to a selected menu command or to a voice-activated command of said user, using a voice recognition capability of said promotional software application, by interacting with a browser application on said personal computer system to launch said browser application and to access a web site of said business entity using said browser application, wherein said web site provides a key word search capability of a database of said business entity.

26. The method of claim 1 further comprising said promotional software application responding to a selected menu command or to a voice-activated command of said user, using a voice recognition capability of said promotional software application, by interacting with a browser application launching on said personal computer system to launch said browser application and to access a web page using said browser application, and wherein said promotional software application reads at least text provided by said web page using a speech synthesis capability of said promotional software application.

27. The method of claim 1 further comprising said promotional software application responding to a selected menu command or to a voice-activated command of said user, using a voice recognition capability of said promotional software application, by interacting with a notepad application on said personal computer system to launch said notepad application and to display a functional user interface of said notepad application on said personal computer system.

28. The method of claim 1 further comprising said promotional software application responding to a selected menu command or to a voice-activated command from said user, using a voice recognition capability of said promotional software application, by launching a peer-to-peer chat sub-application of said promotional software application on said personal computer system allowing peer-to-peer communication between said user of said personal computer system and a second user of a second personal computer system.

29. A promotional software application to promote a business entity's branded products and/or services, said software application comprising:
an animation capability to display an animated character on a desktop of a personal computer system of a user on which said promotional software application is installed, and wherein a design of said animated character promotes branded products and/or services of said business entity;
an information gathering capability wherein said promotional software application automatically and periodically accesses a computer-based networked system associated with said business entity, via a global informational network connected between said computer-based networked system and said personal computer system, and gathers promotional information from said computer-based networked system and brings said promotional information back to said personal computer system; and
a user interface capability to facilitate communication between said promotional software application and said user.

30. The method of claim 29 wherein said promotional software application is provided to said user by a promotional service provider.

31. The method of claim 30 wherein said business entity comprises a client of said promotional service provider.

32. The promotional software application of claim 29 wherein said computer-based networked system comprises a server.

33. The promotional software application of claim 29 wherein said animated character is continuously displayed on said desktop.

34. The promotional software application of claim 29 wherein said user interface capability facilitates the communication of information from said promotional software application, via said animated character, to said user.

35. The promotional software application of claim 29 wherein said user interface capability facilitates the communication of commands from said user to said promotional software application.

36. The promotional software application of claim 29 wherein said two-way user interface capability includes a voice recognition capability to receive voice-activated commands from said user such that said promotional software application receives and responds to said voice-activated commands.

37. The promotional software application of claim 29 wherein said two-way user interface capability includes a voice synthesis capability to convert digital information to speech and to communicate said speech to said user via said animated character on said desktop of said personal computer system.

38. The promotional software application of claim 29 wherein said two-way user interface capability includes a menu-selection capability to present selectable command options to a user in the form of a displayed menu and to accept and execute a selected option.

39. The promotional software application of claim 29 wherein said two-way user interface capability includes a text display capability to display text information to said user.

40. The promotional software application of claim 29 further comprising an application interaction capability such that said promotional software application interacts with at least one other software application on said personal computer system when said user initiates said interaction.

41. The promotional software application of claim 29 further comprising an application monitoring capability wherein said promotional software application monitors at least one other software application running on said personal computer system for at least one change in state of said at least one other software application.

42. The promotional software application of claim 29 further comprising at least one sub-application providing at least one of a calculator capability, a peer-to-peer chat capability, and a scheduler capability.

43. The promotional software application of claim 29 further comprising a notification capability to notify said user, using said animated character, when said promotional information is available to be communicated to said user via said animated character.

44. The promotional software application of claim 29 further comprising an application interaction capability providing interaction with an electronic mail application on said personal computer system to access and present an electronic mail message to said user via said animated character using a synthesized audio speech capability and/or a text display capability of said promotional software application in response to a command input by said user via said two-way user interface capability.

45. The promotional software application of claim 29 further comprising an application interaction capability providing interaction with an instant messaging application on said personal computer system to access and present an instant messaging message to said user via said animated character using a synthesized audio speech capability and/or a text display capability of said promotional software application.

46. The promotional software application of claim 29 further comprising an application interaction capability providing interaction with a clipboard application on said personal computer system to access and present text stored in a clipboard memory to said user via said animated character using a synthesized audio speech capability and/or a text display capability of said promotional software application in response to a command input by said user via said two-way user interface capability.

47. The promotional software application of claim 29 further comprising an application interaction capability providing interaction with an address book application on said personal computer system to launch said address book application and to display a functional user interface of said address book application to said user on said personal computer system in response to a command input by said user via said two-way user interface capability.

48. The promotional software application of claim 29 further comprising an application interaction capability providing interaction with a browser application on said personal computer system to launch said browser application and to display a functional user interface of said browser application to said user on said personal computer system in response to a command input by said user via said two-way user interface capability.

49. The promotional software application of claim 29 further comprising an application interaction capability providing interaction with an electronic mail application on said personal computer system to initiate drafting of a new electronic mail message by said user in response to a command input by said user via said two-way user interface capability.

50. The promotional software application of claim 29 further comprising an application interaction capability providing interaction with a system clock on said personal computer system to access and present a current time and/or date to said user via said animated character using a synthesized audio speech capability and/or a text display capability of said promotional software application in response to a command input by said user via said two-way user interface capability.

51. The promotional software application of claim 29 further comprising an application interaction capability providing interaction with a browser application on said personal computer system to launch said browser application and automatically access a web site of said business entity using said browser application in response to a command input by said user via said two-way user interface capability.

52. The promotional software application of claim 29 further comprising an application interaction capability providing interaction with a browser application on said personal computer system to launch said browser application and automatically access a web site of said business entity using said browser application, wherein said web site provides a key word search capability of a database of said business entity, in response to a command input by said user via at least one of said two-way user interface capability and a keyboard of said personal computer system.

53. The promotional software application of claim 29 further comprising an application interaction capability providing interaction with a browser application on said personal computer system to launch said browser application and access a web page using said browser application in response to a command input by said user via said two-way user interface capability, and wherein said promotional software application reads at least text provided by said web page using a speech synthesis capability of said promotional software application.

54. The promotional software application of claim 29 further comprising an application interaction capability providing interaction with a notepad application on said personal computer system by launching said notepad application and displaying a functional user interface of said notepad application on said personal computer system in response to a command input by said user via said two-way user interface capability.

55. A method to provide inspirational and motivational messages, said method comprising:
running a software application on a personal computer system to display an animated character on a desktop of said personal computer system, wherein a design of said animated character promotes inspirational and motivational thoughts in a user of said personal computer system; and
said software application automatically and periodically communicating said inspirational and motivational messages to said user via said animated character.

56. The method of claim 55 wherein said software application is provided to said user by a business entity for a fee.

57. The method of claim 55 wherein said software application is installed on said personal computer system by said user.

58. The method of claim 55 wherein said running of said software application on said personal computer system is initiated by said user.

59. The method of claim 55 wherein said animated character is displayed persistently on said desktop.

60. The method of claim 55 further comprising said software application interacting with at least one other software application installed on said personal computer system when said user of said personal computer system initiates said interaction.

61. The method of claim 55 further comprising said software application monitoring at least one other software application running on said personal computer system for at least one change in state of said at least one other software application.

62. The method of claim 55 further comprising said software application launching a sub-application of said software application in response to a command from said user.

63. The method of claim 55 wherein said inspirational and motivational messages are communicated to said user via said animated character through said personal computer system using at least one of a speech synthesis capability of said software application, a displayed text capability of said software application, specific animations of said animated character, and other displayed graphics provided by said software application.
